(19) United States
(12) Patent Application Publication
(10) Pub. No.: US 2017/0230280 A1
(43) Pub. Date: Aug. 10, 2017

(54) HOME AUTOMATION DEVICE HAVING AN ALTERNATIVE COMMUNICATION LINK WITH A REMOTE COMPUTER SERVER

(71) Applicant: MYFOX, Labege (FR)

(72) Inventors: Jean-Marc PRUNET, Paris (FR); Stephane BACOU, Castanet-Tolosan (FR); Emmanuel PREVOST, Malakoff (FR)

(73) Assignee: MYFOX, Labege (FR)

(21) Appl. No.: 15/502,323

(22) PCT Filed: Jul. 8, 2015
(86) PCT No.: PCT/EP2015/065604

§ 371 Date: Feb. 7, 2017

(30) Foreign Application Priority Data
Aug. 8, 2014 (FR) 14 57719

(51) Int. Cl. H04L 12/703; H04L 12/28; H04L 12/707

(52) U.S. Cl. CPC H04L 45/28; H04L 45/22; H04L 12/2818

(57) ABSTRACT

Disclosed is a home-automation device, a method, a computer program and a home-automation computing unit in which a main home-automation computing unit (30) belonging to a main local network (32) emits a home-automation message to a computer server (35) by a main link (33) and, if there is a fault in the main link (33), re-emits the home-automation message by a translocal link (36, 55), distinct from the main link, directly to a neighbouring computing unit (38, 43) belonging to a neighbouring local network (40, 45) which sends the home-automation message to the computer server (35) by a neighbouring link (37, 46).

The invention relates to a home-automation device comprising at least two home-automation computing units, to such a home-automation computing unit, to a method implemented in such a home-automation computing unit and in such a home-automation device, allowing the provision of a redundant communication link between a home-automation computing unit and a receiving device.

Numerous home-automation applications require, for reasons of safety or convenience, that a home-automation computing unit is permanently accessible by telecommunication links, either for the state thereof to be controllable or for it to be possible to receive notifications from this device. In particular, in the case of a home-automation alarm computing unit, a user wishes to be immediately informed of an incident occurring in monitored premises, such as his home for example.

Numerous home-automation devices are connected to a user interface via the Internet. More particularly, numerous home-automation devices are part of a local network of electronic apparatuses, all connected by a single router to the Internet (cf. for example US 2009/0036159). However, this connection model poses the problem of an Internet outage which cuts the telecommunication link between the user and the home-automation device. Such an outage can have many causes, whether technical or as a result of fraudulent activity, on a network line or on the router of the local network, including electrical power cuts. In particular, in the case of a home-automation computing unit for monitoring premises and/or objects, a cut in the link between the home-automation computing unit and the user via the Internet can be ill-intentioned.

This is why some home-automation devices are adapted to be able to communicate over a mobile telephone-type network, e.g. GSM, as an emergency telecommunication link in case of the access to the Internet being cut off.

However, this type of solution is costly for the user. In fact, it sometimes requires the user having to buy an additional device allowing a relay on the GSM network, or even an additional antenna for communicating over this network. In addition, a user must buy access to this network, which is often a monthly subscription whereas the probability of using this emergency network is very low and, in any case, very occasional.

The invention thus aims to overcome these disadvantages.

The invention aims to propose a home-automation device providing a redundant telecommunication link between a home-automation computing unit and a receiving device.

The invention aims in particular to propose such a home-automation device which is reliable and resistant to any loss in connection by the Internet between a home-automation computing unit and a receiving device.

The invention likewise relates to such a home-automation computing unit.

The invention aims to propose such a computing unit which is economical to use.

The invention relates more particularly to such a computing unit which is reliable.

The invention further aims to propose such a computing unit which is autonomous in terms of energy.

The invention further relates to a method implemented by such a device allowing reliable operation of such a computing unit.

The invention also relates to a method implemented by such a computing unit in such a device, adapted such that the computing unit is simple to install, to configure and to use.

The invention thus relates to a home-automation device comprising:
a first home-automation computing unit, named main computing unit,
an electronic device, named receiving device, connected to said main computing unit by a first data communication link, named main link,
said main computing unit belonging to a first local network, named main local network, of electronic devices which are distinct and remote from the receiving device, this main local network having its own access, via a password, to the Internet, said main link comprising a communication link of the Internet,
   said main computing unit being adapted to:
receive signals, named home-automation signals, from at least one home-automation sensor,
process said home-automation signals and produce digital data representing a message, named home-automation message, based on said home-automation signals,
be able to emit said home-automation message to said receiving device by said main link, characterised in that it comprises a second home-automation computing unit, named neighbouring computing unit, belonging to a second local network, named neighbouring local network, of electronic devices which are distinct and remote from the receiving device, this neighbouring local network having its own access, via a password, to the Internet, said neighbouring link comprising a communication link of the Internet,
   in that said receiving device is connected to said neighbouring computing unit by a second data communication link, named neighbouring link, distinct from the main link,
   and in that said main computing unit is adapted to:
be able to detect a cut in said main link,
be able to establish a data communication link, named translocal link:
   distinct from said main link,
   distinct from said neighbouring link,
   with said neighbouring computing unit,
upon detection of a cut in said main link, be able to re-emit said home-automation message to said neighbouring computing unit by said translocal link,
   and in that said neighbouring computing unit is adapted to:
be able to receive, over said translocal link, said home-automation message from said main computing unit,
be able to emit said home-automation message to said receiving device by said neighbouring link—in particular without reading or extracting the content of said home-automation message.

A home-automation device in accordance with the invention is in particular a set of electronic and/or computing hardware, software, information in the form of digital data organised in files and/or in databases, and analogue and/or digital data communication links between said hardware, able to fulfil predetermined functions.

A device in accordance with the invention advantageously comprises a plurality of home-automation computing units in accordance with the invention, i.e. a plurality of home-automation computing units mutually connected by translocal links. Thus, advantageously and in accordance with the invention, said home-automation computing units form a telecommunication network based on said translocal links, in particular a machine-to-machine telecommunication network. More particularly, the home-automation computing units in accordance with the invention are adapted to form an ad hoc communication network.

Advantageously and in accordance with the invention, said translocal link allows a direct link between said main computing unit and said neighbouring computing unit, i.e. a communication link without an intermediate relay device between said main computing unit and said neighbouring computing unit.

Electronic apparatuses having distinct functions and a distinct design of a home-automation computing unit in accordance with the invention can advantageously communicate with each other or with this home-automation computing unit via said translocal link.

More particularly, home-automation computing units of a home-automation device in accordance with the invention can ensure, as their primary aim, functions which are extremely different from each other (e.g. monitoring of premises, geolocation of objects, managing of air-conditioning, management of openings, etc.) whilst being capable of sending, via said translocal link, home-automation messages received from another home-automation computing unit of a different type.

The invention also relates to a home-automation computing unit, named main computing unit, adapted to:
receive signals, named home-automation signals, from at least one home-automation sensor,
process said home-automation signals and produce digital data representing a message, named home-automation message, based on said home-automation signals,
be able to emit said home-automation message to a receiving device by a first data communication link, named main link, comprising a communication link of the Internet, said main computing unit belonging to a first local network, named main local network, of electronic devices which are distinct and remote from the receiving device, this main local network having its own access, via a password, to the Internet,
   characterised in that it is adapted to:
be able to detect a cut in said main link,
be able to establish a data communication link, named translocal link:
   distinct from the main link,
   with a second home-automation computing unit, named neighbouring computing unit, adapted to be able to emit said home-automation message to said receiving device—in particular without reading or extracting the contents of said home-automation message—by a second data communication link, named neighbouring link, comprising a communication link of the Internet, distinct from the main link and the translocal link, said neighbouring computing unit belonging to a second local network, named neighbouring local network, of electronic devices which are distinct and remote from the receiving device, this neighbouring local network having its own access, via a password, to the Internet,
   upon detection of a cut in said main link, be able to re-emit said home-automation message to said neighbouring computing unit, by said translocal link.

A home-automation computing unit in accordance with the invention is an electronic device having home-automation functions. A home-automation computing unit in accordance with the invention is adapted to ensure monitoring of premises, such as a home, a business, e.g. a warehouse, an office block, etc. It receives in particular home-automation sensor signals allowing said premises to be monitored, and emits alarm or alert messages to users or to alerting devices (a siren for example). Thus, such a home-automation computing unit provides for example an anti-intrusion alarm function and allows alarms to be triggered or a predefined person to be warned upon detection of an intrusion in said monitored premises.

Advantageously and in accordance with the invention, the neighbouring computing unit and the main computing unit in accordance with the invention have at least in common the ability to communicate directly with each other, in particular to send home-automation messages, via said translocal link regardless of the home-automation functions they respectively provide.

The neighbouring computing unit and the main computing unit thus have in common main functions in accordance with the invention allowing them to exchange home-automation messages via said translocal link. Throughout the text, the features described in relation to the main computing unit are thus also applicable to each neighbouring computing unit, and vice-versa. Classifying a home-automation computing unit in accordance with the invention as “main” or “neighbouring” results solely from a particular point of view.

The main and neighbouring home-automation computing units in accordance with the invention are, in some cases, similar or even identical, sometimes identical except for differences relating to the technological and/or economic trends of electronic components and/or except for differences relating to the trends of operating software.

In particular, advantageously and in accordance with the invention, said neighbouring computing unit is further adapted to:
be able to detect a cut in said neighbouring link,
upon detection of a cut in said neighbouring link, be able to re-emit said home-automation message to another home-automation computing unit, by said translocal link.

The other home-automation computing unit can be the main computing unit or a neighbouring computing unit other than said neighbouring computing unit which re-emits said home-automation message by said translocal link.

In addition, advantageously and in accordance with the invention, said neighbouring computing unit is further adapted to:
a. receive signals, named home-automation signals, from at least one home-automation sensor,
b. process said home-automation signals and produce digital data representing a message, named home-automation message, based on said home-automation signals.

In addition, said main computing unit is advantageously adapted to re-emit, upon receiving a home-automation message from said neighbouring computing unit by said translocal link, said home-automation message by said main link.

Advantageously, the main computing unit verifies that its main link is operational—in particular that it has not been cut—before re-emitting the home-automation message from the neighbouring computing unit to said receiving device by said main link.

The neighbouring local network is separate from the main local network. In particular, each home-automation local network in accordance with the invention (main or neighbouring) has its own access to the Internet, in particular each local network in accordance with the invention has its own Internet access router.

Each local network thus has a priori a communication link with the receiving device, in particular with a computer server not belonging to said local network.

Advantageously and in accordance with the invention, said main link and said neighbouring link are telecommunication links at least partly using the Internet.

In some embodiments, advantageously and in accordance with the invention:
said main computing unit is connected to an Internet access router by a local link of said main link,
said neighbouring computing unit is connected to an Internet access router by a local link of said neighbouring link.

A local network in accordance with the invention comprises a plurality of electronic apparatuses. In a local network in accordance with the invention, at least one of said electronic apparatuses has access to the Internet and shares it with the other electronic apparatuses forming part of said local network. This apparatus is generally a router. In addition, in general each electronic apparatus of said local network must contain in its memory a password set for this local network to be able to use the Internet access of this local network.

The apparatuses of one local network are generally located in the same premises or group of premises (individual house or apartment for example) and are connected by wires or wirelessly (Wi-Fi® for example) to a router providing access to the Internet. A local network thus corresponds in general to the local network of a family home or business.

The neighbouring local network is often formed in a similar manner to the main local network. However, there is nothing to prevent, in accordance with the invention, the local network from differing from the main local network, e.g. in the nature of the neighbouring link and main link. Thus, the neighbouring link may be based on a wireless telecommunication network of the GRPS, UMTS, LTE type and the main link may be based on a wired telecommunication network of the ADSL telephony type or by optical fibres.

The invention applies advantageously to a home-automation computing unit not having its own means for accessing the Internet. However, the invention also advantageously applies to a home-automation computing unit in accordance with the invention comprising its own means for accessing the Internet. In fact, if the router of a local network may fail and deny a home-automation computing unit from accessing the Internet, the means of said home-automation computing unit for communicating directly over the Internet may also be out-of-service (e.g. because a GPRS, UMTS, LTE subscription has not been renewed).

Furthermore, each home-automation sensor in accordance with the invention advantageously comprises a home-automation signal communication link with a single home-automation computing unit. Each home-automation sensor is advantageously adapted to be able to communicate with a home-automation computing unit in accordance with the invention by its own communication link, wired or wireless.

The home-automation sensor can be part of the home-automation computing unit (e.g. be mounted on a printed circuit board common to a data processing unit of the home-automation computing unit) or be physically separate therefrom.

More particularly, at least one of said home-automation sensors has a wireless communication link, named home-automation link, with said home-automation computing unit. Said home-automation link has a small optimum range, e.g. less than 1 km, in particular less than 500 m, more particularly less than 100 m indoors. Thus, said home-automation link is e.g. a radiofrequency link, for example in accordance with one of the IEEE 802.15.4 standards, e.g. of the Zigbee® type.

Advantageously and in accordance with the invention, at least one home-automation sensor is selected from: a fire detector, a movement detector, in particular an infrared detector, a leaf-opening detector, an accelerometric detector, a magnetometric detector, a camera, a microphone, a power supply outage detector, a contact detector, a water detector, a thermometer, a luxmeter in particular a photovoltaic sensor, a gas detector, in particular a carbon monoxide detector, an oxygen level detector, a carbon dioxide detector, a water vapour level detector (humidity sensor), a seismic detector, a glass break detector, a detector of breakdowns or faults in electrical or mechanical devices, an emergency call or assistance pendant, a water consumption sensor in particular a water meter, an electricity consumption sensor, in particular an electricity meter, a gas consumption sensor, in particular a gas meter, a fuel consumption sensor, a GPS locating device, a tachometer, a pressure sensor, an anemometer, a person-monitoring sensor, in particular a heart-rate sensor, a blood pressure sensor, an oxygen saturation sensor, a respiratory rate sensor, etc.

The home-automation computing unit is adapted to centralise and process home-automation signals from a plurality of home-automation sensors. The home-automation computing unit is adapted to produce data representing messages, named home-automation messages, based on the home-automation signals received from one or more home-automation sensors. The home-automation computing unit is adapted to emit such a home-automation message to a receiving device, i.e. said home-automation message comprises at least one address zone, said address zone being supplemented by an identifier of said receiving device stored in a memory of said home-automation computing unit.

Advantageously and in accordance with the invention, said receiving device is advantageously a computer server. The computer server is generally remote from each home-automation computing unit. In particular, the computer server is generally out of the range over exclusively wireless links of a majority of home-automation computing units in accordance with the invention.

The computer server is, for example, a physical computer server or a network of computer servers in the cloud.

The computer server is advantageously a computer server centralising exchanges of information:
between each home-automation computing unit in accordance with the invention and a user interface electronic device (computer, mobile electronic apparatus, etc.), and/or
between home-automation computing units in accordance with the invention.

The computer server can process such information in the form of digital data.

The computer server comprises a memory in which information relating to the home-automation computing units in accordance with the invention is stored.

More particularly, the computer server comprises in its memory a server table containing identifiers of a plurality of home-automation computing units in accordance with the invention.

Said server table advantageously further comprises information relating to each home-automation computing unit in accordance with the invention, for example, the geographic location thereof. The geographic location thereof can be determined by the computer server based on the Internet address (IP address) of the local network to which said home-automation computing unit belongs, or from an address associated with a subscription for services linked with said device (e.g. a remote monitoring service in the case of an alarm device) or even based on an address given by a user.

Said server table of the computer server can also comprise one or more encryption keys associated with each identifier of a home-automation computing unit.

A neighbouring local network is generally secure and thus cannot be accessed by an external electronic device which does not have a key or password enabling it to connect thereto. Such local networks are thus neighbours in geographic terms but are closed and do not exchange data with each other.

The invention allows a home-automation computing unit to send home-automation messages to said receiving device via the neighbouring link of the neighbouring local network, without having particular authorisation—in particular without having an encryption key or password of the neighbouring local network—simply by sending home-automation messages to said neighbouring computer unit by said translocal link, said neighbouring computing unit being tasked with sending them via said neighbouring link because said neighbouring computing unit belongs to the neighbouring local network and is to this end authorised to use said neighbouring link.

The invention allows a home-automation computing unit in accordance with the invention already having a communication link with the Internet to have an alternative machine-to-machine communication link with at least one other home-automation computing unit provided with means for communicating over said translocal link and also having access to the Internet.

The invention allows a home-automation computing unit to emit home-automation messages via a link to the Internet of a local network other than the local network to which it belongs.

The invention thus advantageously affords a home-automation computing unit a possibility of communicating with the computer server despite a main link being out-of-service between the main local network to which it belongs and the computer server.

The invention thus allows a home-automation computing unit to have an emergency communication link with the receiving device. In a further advantageous manner, the link from main computing unit to neighbouring computing unit is a free emergency link without using an existing telecommunication network requiring a subscription and/or producing quantitative invoicing, such as a GSM or GPRS telecommunication network for example.

Advantageously, a home-automation computing unit in accordance with the invention is adapted to send only predetermined home-automation messages to said receiving device.

Advantageously and in accordance with the invention, said main computing unit is adapted to be able to re-emit said home-automation message to said neighbouring computing unit by said translocal link in accordance with a predetermined communication protocol, named home-automation translocal protocol. More particularly, a home-automation computing unit in accordance with the invention is adapted to send only home-automation messages with a predetermined format via said translocal link.

In addition, advantageously and in accordance with the invention, upon receipt of a home-automation message by said translocal link, said neighbouring computing unit is adapted to send said home-automation message to said receiving device by said neighbouring link only if said home-automation message is established in accordance with the home-automation translocal protocol.

Thus, in accordance with the invention, only home-automation messages with a predetermined format can pass by said neighbouring link between said main computing unit and said receiving device.

In some embodiments of the invention, the neighbouring computing unit is adapted to send said home-automation message to said receiving device by said neighbouring link only if it corresponds to an element from a list, named authorised list, comprising a plurality of typical, predetermined home-automation messages which are authorised to be sent via said neighbouring link. Said authorised list comprises typical home-automation messages, for example “door open”, “refrigerator temperature low”, “intrusion detected”, etc. Said authorised list is advantageously stored in a memory of the neighbouring computing unit.

The home-automation messages of said main computing unit can pass by the neighbouring local network and the neighbouring link but they cannot be sent to apparatuses of the neighbouring local network other than the neighbouring computing unit and the apparatuses located over the neighbouring link between said neighbouring computing unit and the computer server.

Furthermore, in a device in accordance with the invention, said main computing unit advantageously encrypts at least part of a home-automation message to be sent to the receiving device using an encryption key which is not held by said neighbouring computing unit.

Thus, advantageously and in accordance with the invention, a communication tunnel is established between said main computing unit and said receiving device without a home-automation message being able to be extracted therefrom, e.g. by said neighbouring computing unit, and without said message being able to leave said tunnel, e.g. to an apparatus of the neighbouring local network. In particular, neither an apparatus of the neighbouring local network nor said neighbouring computing unit can read the content of the home-automation messages exchanged between the main computing unit and the receiving device via said neighbouring local network.

In particular, said main computing unit advantageously encrypts the informative content (body) of the message. In particular, advantageously and in accordance with the invention, said main computing unit is adapted to encrypt a body of the home-automation message with a key which the receiving device has but the neighbouring computing unit does not have. Thus, said neighbouring computing unit cannot extract the information contained in said home-automation message of said main computing unit.

A home-automation computing unit in accordance with the invention encrypts, for example, the informative content (or body) of the message with an encryption protocol of the RSA or AES type.

Advantageously and in accordance with the invention, it is thus impossible for a home-automation computing unit in accordance with the invention to access a neighbouring local network, to determine which electronic apparatuses are part of said neighbouring local network, to know the nature and/or number of home-automation sensors connected to the neighbouring computing unit, etc. Similarly, it is impossible for a home-automation computing unit in accordance with the invention to extract information from a home-automation message passing through it via said translocal link. Similarly, it is impossible for a home-automation computing unit in accordance with the invention to broadcast data to be sent to one or more apparatuses of the neighbouring local network.

More particularly, a home-automation message emitted by said main computing unit over said translocal link in accordance with said home-automation translocal protocol cannot represent a request for information relating to said neighbouring computing unit or the neighbouring local network. Furthermore, in some embodiments of the invention, only some types of messages can pass through the neighbouring local network. Thus, passing home-automation messages sent by said main computing unit by the neighbouring link is limited to certain types of messages, for example messages alerting a user in the case of a home-automation alarm computing unit providing a monitoring function for premises.

Nevertheless, based on the type of translocal link—in particular based on the data rate of said translocal link—, there is nothing to prevent provision being made that all of the functionalities of the main computing unit are accessible through said translocal link and said neighbouring link. In particular, bidirectional exchanges of data between the main computing unit and computer server can be provided. More particularly, control instructions for a user sent to the computer server can be communicated to said main computing unit. These control instructions can be encapsulated, for example, in the body of a home-automation message. Nevertheless, these home-automation messages, in either direction, are contained in a tunnel through the neighbouring local network such that they cannot leave or be extracted therefrom.

Furthermore, advantageously and in accordance with the invention, said computer server is adapted to be able to communicate by a telecommunication network with at least one human user interface device.

The user of an interface device is, for example, the user of a local network, in particular a home-automation computing unit in accordance with the invention belonging to this local network. The user of an interface device can also be different from the user of said home-automation computing unit: e.g. an employee of a remote monitoring company.

Furthermore, said receiving device in accordance with the invention can be a human user interface device. In this case, advantageously, said main computing unit emits said home-automation message directly to said interface device, without passing through a computer server.

A human user interface device is an electronic, human/machine interface device, e.g. a mobile telephone or an electronic tablet connected to the computer server by a data telecommunication network (e.g. GPRS).

Said electronic interface device is advantageously adapted to establish bidirectional communication with said main computing unit via said computer server. Thus, a user can receive information regarding the status of at least one home-automation parameter monitored or collected by said main computing unit: for example an alarm message relating to an intrusion or a fire detected by a home-automation sensor connected to said main computing unit.

In addition, a user can also control said main computing unit remotely via said computer server and said main link with the main local network or via said computer server and a neighbouring link and then the translocal link between at least one neighbouring computing unit and said main computing unit.

By way of a device in accordance with the invention, a user, named main user, of the main computing unit receives messages from said main computing unit on an interface device, even if the main link between said main computing unit and the computer server is faulty. This is advantageously fully transparent for each user, named neighbouring user, of a neighbouring computing unit which transfers the messages of the main computing unit to said receiving device.

Said home-automation computing unit advantageously comprises an emergency power supply. An emergency power supply comprises, for example, one or more of the following elements, individually or in combination: a battery, a photovoltaic panel, etc.

In the computer networks, a cut or fault in said main link is detected in particular by the main computing unit by the absence of information feedback after a predetermined time period.

Thus, advantageously, in a method in accordance with the invention, said main computing unit:
emits a home-automation message to a receiving device via said main link and triggers a timer,
compares the value of said timer with a value representing a predetermined time period, named waiting time period,
re-emits said home-automation message via said translocal link if the waiting time period has expired without an acknowledgement message from said receiving device.

Advantageously and in accordance with the invention, said neighbouring computing unit is adapted to receive an acknowledgement message from said receiving device and to send it to said main computing unit by said translocal link.

Thus, advantageously, in a method in accordance with the invention, when said main computing unit:
emits a home-automation message to a receiving device to a first neighbouring computing unit via said translocal link, it triggers a timer, then
compares the value of said timer with a value representing a predetermined time period,
re-emits said home-automation message to a second neighbouring computing unit via said translocal link if the waiting time period has expired without an acknowledgement message from said receiving device.

Said main computing unit successively sends its home-automation message via said translocal link to each neighbouring computing unit for which it has the identifier in a routing table until an acknowledgement from the receiving device is returned to it or until it reaches the end of its routing table. If it reaches the end of the routing table, it goes through the table again until it receives an acknowledgement.

In addition, advantageously, in a device in accordance with the invention said main computing unit is adapted to re-emit, upon receipt of a home-automation message from said neighbouring computing unit by said translocal link and upon detection of a cut in said main link, said home-automation message by said translocal link to a second neighbouring computing unit.

In particular, a computing unit in accordance with the invention is advantageously adapted to re-emit, upon receipt of a home-automation message from said neighbouring computing unit by said translocal link and upon detection of a cut in said main link, said home-automation message by said translocal link to a second neighbouring computing unit.

More particularly, said main computing unit is adapted to re-emit, upon receipt of a home-automation message from said neighbouring computing unit by said translocal link and upon detection of a cut in said main link, said home-automation message by said translocal link to a second neighbouring computing unit:
belonging to a second neighbouring local network,
adapted to be able to emit signals representing a home-automation message to said receiving device by a second neighbouring link.

The invention allows instances of Internet faults and/or electrical faults throughout a building, or even throughout a district, to be overcome. In fact, the invention allows data to be sent by successive transfers (“jumps”) of a home-automation message from home-automation computing unit to home-automation computing unit as far as at least one home-automation computing unit of which the communication link with the receiving device is operational. This(these) home-automation computing unit(s) in accordance with the invention located alongside the zone having no main link(s) with the computer server thus allow(s) all the home-automation computing units in accordance with the invention of the zone having no main link(s) to communicate with the computer server.

An alternative direct telecommunication network between home-automation computing units is thus created. More particularly, a plurality of home-automation computing units in accordance with the invention advantageously form an ad hoc network.

Advantageously and in accordance with the invention, said translocal link is a wireless communication link.

Thus, a main computing unit can establish a translocal communication link with a neighbouring computing unit without any particular hardware and without an additional installation between the main local network and the neighbouring local network.

Advantageously, the main computing unit establishes a translocal communication link with each neighbouring computing unit in an automated manner, without any particular action on the part of the user. Thus, a home-automation computing unit in accordance with the invention is simple to install and to configure.

Advantageously and in accordance with the invention, said translocal link is a telecommunication link operating with a wireless telecommunication technology with a maximum range greater than the maximum range of the main local network.

In particular, the translocal link advantageously operates with a telecommunication technology with a maximum range greater than the current maximum range of Wi-Fi® (IEEE 802.11x standard). In fact, the majority of local networks currently use Wi-Fi® links; this is particularly the case in local networks in the homes of individuals, the maximum range of which in urban regions is less than 100 m.

Furthermore, the translocal link advantageously operates with a telecommunication technology suitable for passing through obstacles (such as walls) more effectively than in the case of Wi-Fi® as currently defined. Thus, a translocal link in accordance with the invention advantageously operates with a telecommunication technology having a range of at least 500 m in urban regions or 1 km in rural regions, in particular at least 1.5 km in urban regions or 5 km in rural regions, and more particularly advantageously at least 3 km in urban regions or 10 km in rural regions.

Nevertheless, alternatively or in combination, there is nothing to prevent provision being made in some embodiments of the invention that the translocal link can operate using a wireless network with a limited range, such as Wi-Fi®. Thus, this may be advantageous in some areas with a high density of home-automation computing units in accordance with the invention and/or in the case of a fault in the specific telecommunication link of the translocal link.

In addition, advantageously and in accordance with the invention, said translocal link is an encrypted communication link.

Encrypting the translocal link implements, for example, a method in which two computing units (main and neighbouring, or two neighbouring) exchange encryption keys directly by said translocal link and/or via said main and neighbouring links via the computer server which advantageously contains in its memory at least one encryption key for the main computing unit and each neighbouring computing unit.

Said translocal link is, for example, encrypted by an SSL/TLS -type protocol.

Advantageously and in accordance with the invention:
said main computing unit comprises at least one memory in which there is stored at least one identifier, named main identifier, which is specific to it,
said main computing unit is adapted to be able to emit a signal, named searching signal, comprising said main identifier, by said translocal link,
said neighbouring computing unit comprises at least one memory in which there is stored at least one identifier, named neighbouring identifier, which is specific to it,
said neighbouring computing unit is adapted to emit, upon receipt of said searching signal, a signal, named peering signal, comprising said neighbouring identifier, by said translocal link,
said main computing unit is adapted to store, upon receipt of said peering signal, said neighbouring identifier in a memory.

Said main identifier and said neighbouring identifier are, for example, MAC address-type identifiers.

This allows a home-automation computing unit in accordance with the invention to discover and/or establish a communication network over said translocal link with the other home-automation computing units within range.

Furthermore, advantageously and in accordance with the invention, said neighbouring computing unit is adapted to be able to emit a searching signal further comprising a neighbouring identifier by said translocal link. Advantageously, said main computing unit comprises a plurality of neighbouring identifiers in its memory and sends a searching signal for each stored neighbouring identifier. In particular, said neighbouring computing unit sends at least one searching signal for each neighbouring identifier that it receives from a computer server in response to a registration message sent by said main computing unit to said computer server.

In addition, advantageously and in accordance with the invention,
said main computing unit is adapted to emit, upon receipt of said searching signal, a signal, named peering signal, comprising said main identifier, by said translocal link,
said neighbouring computing unit is adapted to store, upon receipt of said peering signal, said main identifier in a memory.

Furthermore, the home-automation computing unit in accordance with the invention is also advantageously characterised in that it comprises at least one memory adapted to be able to store a plurality of distinct identifiers for distinct neighbouring computing units.

More particularly, said main computing unit is adapted to be able to store in its memory a plurality of identifiers for neighbouring computing units in the form of a list or table, named routing table. Each home-automation computing unit in accordance with the invention advantageously comprises in its memory a routing table in which there are listed all the identifiers of the neighbouring computing units within range over said translocal link, and with which it has exchanged its identifier.

Alternatively or in combination with the emission of a peering signal over the translocal link, there is nothing to prevent—as soon as the main link and the neighbouring link are operational—the neighbouring computing unit from emitting a peering signal to said main computing unit across the neighbouring link, the computer server and the main link, and not by said translocal link. Thus, the computer server can also attach to the peering signal an encryption key for the communication of said main computing unit with said neighbouring computing unit.

Advantageously and in accordance with the invention, the memory of the main computing unit is adapted to be able to store, with each identifier of each neighbouring computing unit, an encryption key to be used to securely communicate with said neighbouring computing unit by said translocal link or by said main link and said neighbouring link.

Alternatively or in combination, when installing a main computing unit, and in particular when it is connected to the main local network, the computer server determines a geographic location based on the Internet address of the main local network, stores it and sends, to said main computing unit, a list of identifiers of neighbouring computing units located geographically close to said main computing unit and theoretically located within the communication range of said main computing unit by said translocal link. Said main computing unit thus emits a searching signal to each neighbouring computing unit in the list provided by the computer server, i.e. it emits a searching signal further comprising an identifier of one of the neighbouring computing units in the list.

Advantageously and in accordance with the invention, the peering signal further comprises a value, named quality value, representing the quality of the translocal link between said main computing unit and said neighbouring computing unit. Upon receipt of said peering signal, said main computing unit advantageously stores said quality value of each neighbouring computing unit with said neighbouring identifier.

In addition, advantageously and in accordance with the invention, the main computing unit is adapted to store in the memory, with each identifier of each neighbouring computing unit, a quality value of the translocal link with this neighbouring computing unit. This value may be based on one of the following criteria, taken alone or in combination, of the connection between a main computing unit and a neighbouring computing unit via said translocal link: signal strength, observed throughput of the translocal link, throughput of the neighbouring link, intermittence of the translocal link or of the neighbouring link, level of authorisation for accessing its neighbouring local network, quality values of the translocal links of the neighbouring computing unit with the neighbouring computing units stored in its own memory, etc.

Advantageously and in accordance with the invention, said main computing unit is adapted to store a plurality of identifiers in the form of a list or table, with a priority order. Said main computing unit establishes a priority order of the neighbouring computing units to which signals are to be emitted in the case of a fault in the main link. The priority order is advantageously based on the quality value, the neighbouring computing units which have the higher communication quality over said translocal link with said main computing unit being contacted first by said main computing unit.

Advantageously and in accordance with the invention, the peering is carried out directly between a main computing unit and neighbouring computing unit without the main computing unit having authorisation (encryption key and/or password) to access the neighbouring local network, in particular the neighbouring link of the neighbouring local network.

In addition, advantageously and in accordance with the invention, the main computing unit is adapted to be able to periodically update data in its routing table. Thus, the main computing unit periodically sends a searching signal to each neighbouring computing unit whose address is in its routing table in order to verify that they are still within the communication range over the translocal link, and in order to update the quality value associated with each identifier of the neighbouring computing unit in order to rearrange, if need be, the priority orders in the routing table.

Advantageously and in accordance with the invention, said device is further characterised in that:
said main computing unit is adapted to be able to emit a first message, named registration message, to the computer server via said main link,
said computer server is adapted to produce and send to said main computing unit, upon receipt of said registration message, a response message containing at least one identifier, named neighbouring identifier, of at least one neighbouring computing unit,
said main computing unit is adapted to be able to emit by said translocal link a signal, named searching signal, comprising:
   at least one identifier, named main identifier, which is specific to it,
   said neighbouring identifier.

Said registration message comprises, for example, an identifier, named main identifier, specific to said main computing unit.

Upon receipt of the registration message, the computer server advantageously stores said main identifier in its memory.

The computer server sends a message responding to said registration message to said main computing unit which contains no, one or more neighbouring identifier(s). Said neighbouring identifiers sent by the computer server to the main computing unit are selected based on the geographic location of the main computing unit. This geographic location is either determined by the computer server, for example from the IP address of the main local network, or even for example from a subscriber number of a user associated with his postal address. Geographic location data can also be sent directly by the main computing unit to the computer server based on a geographic location determined thereby (e.g. by an integrated satellite positioning device) or entered by a user as input data of the main computing unit.

The computer server advantageously stores in its memory the geographic location of said main computing unit by associating it with said main identifier.

Said main computing unit advantageously emits a searching signal to each neighbouring computing unit for which it receives the neighbouring identifier in a provided list sent by the computer server. The computer server sends to said main computing unit a list of identifiers of neighbouring computing units based on a geographic location of the main computing unit. Said geographic location of the main computing unit is, for example, based on the Internet address of the main local network to which said main computing unit belongs.

A main computing unit in accordance with the invention advantageously comprises a data processing unit, in particular a digital data processing unit. The processing unit advantageously comprises at least one microprocessor.

Said processing unit is in particular adapted to store and read data in one or more memories of the main computing unit. In particular, said processing unit comprises at least one internal memory. The memory of the processing unit is adapted to store data representing operating instructions for the processing unit. Said instructions advantageously allow a processing unit in accordance with the invention to implement a method in accordance with the invention.

Advantageously, in a home-automation device in accordance with the invention, the computer server (or network of computer servers in the cloud) is adapted to allow home-automation messages to be exchanged between a first network of home-automation computing units operating with a first type of translocal link and/or first type of home-automation protocol and a second network of home-automation computing units operating with a second type of translocal link and/or a second type of home-automation protocol. Thus, by way of the invention, two telecommunication networks over distinct translocal links can be interconnected such that the extension of a network of home-automation computing units being able to exchange home-automation messages within a home-automation device in accordance with the invention is all the more greater.

In particular, the computer server (or network of computer servers) is adapted to receive a home-automation message produced in accordance with a first communication protocol, extract the informative content of said home-automation message and re-emit it in accordance with a second communication protocol distinct from the first communication protocol. Advantageously, the informative content is encapsulated and encrypted, for example in accordance with an RSA or AES-type protocol.

The invention likewise relates to a method implemented in a home-automation computing unit, named main computing unit, in which said main computing unit:
receives signals, named home-automation signals, of at least one home-automation sensor,
processes said home-automation signals and produces digital data representing a message, named home-automation message, based on said home-automation signals,
emits signals representing a message, named home-automation message, to a receiving device by a first data communication link, named main link, comprising a communication link of the Internet, said main computing unit belonging to a first local network, named main local network, of electronic devices which are distinct and remote from the receiving device, this main local network having its own access, via a password, to the Internet,
   characterised in that said main computing unit:
detects a cut in said main link,
re-emits said home-automation message over a data communication link, named translocal link, distinct from the main link, to a second home-automation computing unit, named neighbouring computing unit, adapted to be able to emit said home-automation message to said receiving device by a second data communication link, named neighbouring link, comprising a communication link of the Internet, distinct from the main link—in particular without reading or extracting the contents of said home-automation message—said neighbouring computing unit belonging to a second local network, named neighbouring local network, of electronic devices which are distinct and remote from the receiving device, this neighbouring local network having its own access, via a password, to the Internet.

In addition, advantageously and in accordance with the invention, said method is further characterised in that, upon receipt of a home-automation message from a first neighbouring computing unit via said translocal link, and upon detection of a cut in said main link, said main computing unit re-emits said home-automation message to a second neighbouring computing unit via said translocal link.

The method implemented by the main computing unit and the method implemented by each neighbouring computing unit are thus advantageously in accordance with the invention. In particular, the method for operating the main computing unit is advantageously similar, and more particularly identical, to the method for operating each neighbouring computing unit.

The invention likewise relates to a method implemented by a home-automation device in accordance with the invention, in particular a method for operating a home-automation device in accordance with the invention.

The invention relates to a computer program comprising program code instructions for performing the steps of a method in accordance with the invention when the program is run on a computer, in particular on an electronic device, and more particularly on a home-automation computing unit in accordance with the invention.

The invention relates in particular to a computer program comprising instructions for performing a method in accordance with the invention when the program is run by a device comprising at least one digital data processing unit, in particular a home-automation computing unit in accordance with the invention.

The invention relates to a storage medium on which a program in accordance with the invention is stored, as well as to a device in which such a program is stored, in particular a home-automation computing unit comprising a memory in which such a program is stored.

The invention likewise relates to an electronic device, named extension device, comprising:
a digital data processing unit,
a digital memory,
an antenna adapted to be able to emit and receive wireless signals over a telecommunication link, named translocal link,
a connection port, said connection port being adapted to be able to exchange data with a connection port of a home-automation computing unit.

Said extension device allows the provision of means for communicating directly with another home-automation computing unit over said translocal link as defined previously, to a home-automation computing unit which initially has none. Thus, it is sufficient for a home-automation computing unit to comprise a connection port for it to become a home-automation computing unit in accordance with the invention, capable of communicating over an ad hoc network of home-automation computing units, in particular via translocal links as defined above.

Said extension device is further adapted to exchange digital data with said home-automation computing unit when said connection port is connected to a compatible connection port of a home-automation computing unit.

Said extension device advantageously comprises, in its memory, data representing program code instructions for performing the steps of a method in accordance with the invention. In addition, said extension device is adapted to be able to transfer data representing program code instructions for performing the steps of a method in accordance with the invention to a memory of a home-automation computing unit via said connection port.

A connection port of an extension device in accordance with the invention can be hardware in the form of a connector with electrically conductive plugs or a connector with optical fibres. A connection port of an extension device in accordance with the invention can be software, in particular when said extension device is adapted to be able to wirelessly exchange data with said home-automation computing unit.

The extension device is adapted to receive home-automation messages from said home-automation computing unit and wirelessly emit same over said translocal link. The extension device can be adapted to modify a home-automation message received from said home-automation computing unit such that said home-automation message is created in accordance with a predetermined protocol such as the home-automation translocal protocol defined above.

The invention likewise relates to a home-automation device, a home-automation computing unit, a method implemented in a home-automation device, a method implemented by a home-automation computing unit and a computer program, which are characterised in combination by all or some of the features mentioned above or below.

Other aims, features and advantages of the invention will become apparent upon reading the following description given by way of non-limiting example and which makes reference to the attached figures in which:

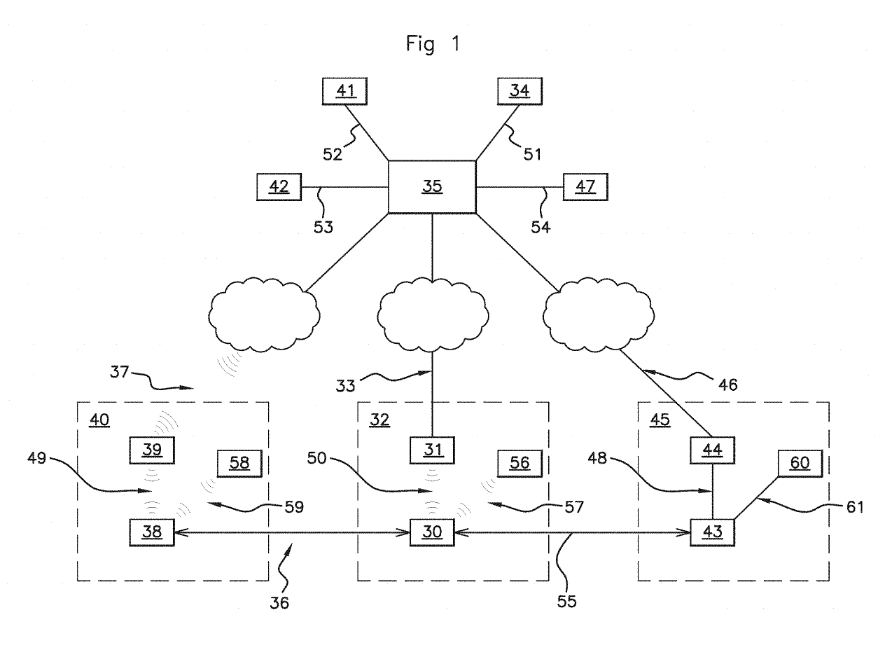

FIG. 1 is a schematic view of a home-automation device in accordance with one embodiment of the invention,

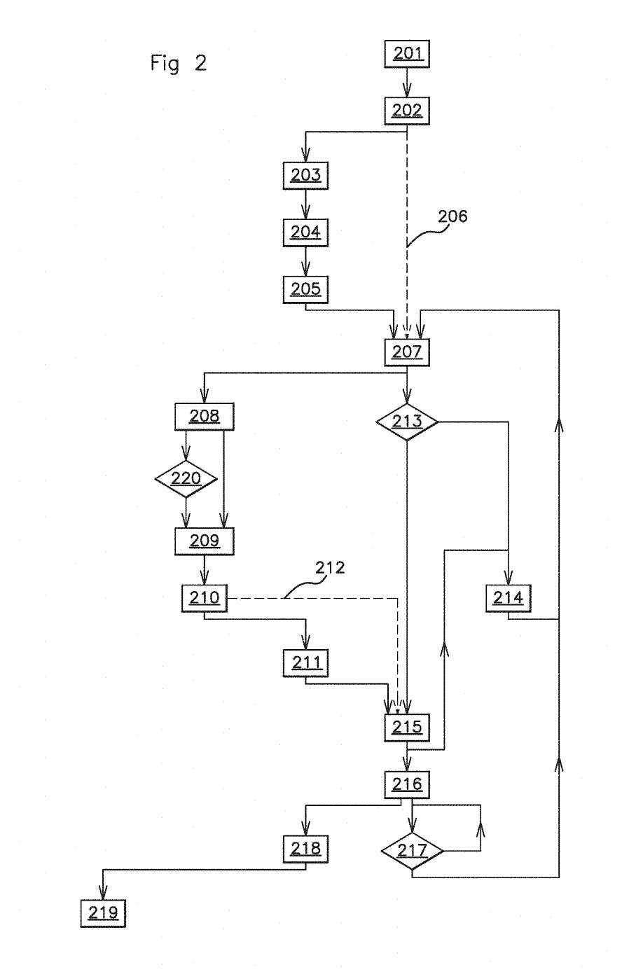

FIG. 2 is an operating diagram of one embodiment of a method in accordance with the invention for initialising a home-automation computing unit in accordance with the invention,

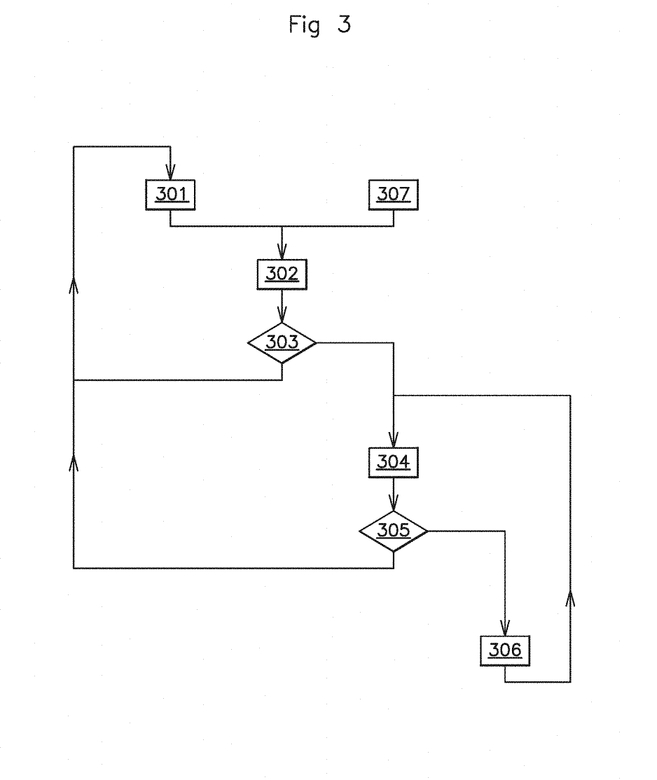

FIG. 3 is an operating diagram of one embodiment of a method in accordance with the invention for operating a home-automation computing unit in accordance with the invention.

A home-automation device in accordance with the invention as shown in FIG. 1 comprises a computer server 35. A router 31 of a local network, named main local network 32, is connected to the computer server 35 by a communication link of the Internet. The router 31 thus provides access to the Internet at the main local network 32.

The grouping of the links and nodes (local link 50, router 31 and link between said main network 32 and the computer server 35) between said main computing unit 30 and the computer server 35 by the local network 32 and the Internet forms said main link 33. Said main link 33 is, for example, provided at least in part by an electrical or optical wired link, e.g. at least in part by a telephony link, such as of the ADSL type.

The main local network 32 comprises a home-automation computing unit in accordance with the invention, named main computing unit 30. Said main computing unit 30 is adapted to receive home-automation signals from at least one home-automation sensor 56 by a wireless communication link, named home-automation link 57.

Said main computing unit 30 is connected to the router 31 by a communication link, named local link 50, of the main local network 32. Said local link 50 is provided by a wireless data communication link, e.g. of the Wi-Fi® type.

Said main computing unit 30 is connected to a user interface device 34, such as a mobile telephone for example, across the local link 50, the router 31, the main link 33, the computer server 35 and a telecommunication link, named external link 51, using, for example, at least in part a mobile telecommunication network, e.g. of the GSM or GPRS type.

In a device in accordance with the invention, advantageously, numerous local networks 40, 32, 45 are connected across the Internet to said computer server 35. Thus, in FIG. 1, two other local networks, named neighbouring networks 40, 45, are shown. Thus, a first neighbouring network 40 comprises a home-automation computing unit in accordance with the invention, named neighbouring computing unit 38, connected by a wireless local link 49 (Wi-Fi® for example) to a router 39. Said router 39 provides a wireless communication link between said neighbouring network 40 and the computer server 35 across the Internet, e.g. by an LTE (4G)-type network. The grouping of the links and nodes (local link 49, router 39 and link between said neighbouring network 40 and the computer server 35) between said neighbouring computing unit 38 and the computer server 35 by the local network 40 and the Internet forms said neighbouring link 37.

Said neighbouring computing unit 38 is adapted to receive home-automation signals from at least one home-automation sensor 58 by a wireless communication link, named home-automation link 59.

Said neighbouring computing unit 38 is connected to two user interface devices 41, 42, such as a mobile telephone and an electronic tablet for example, across the local link 49, the router 39, the neighbouring link 37, the computer server 35 and external links 52, 53.

Similarly, a second neighbouring network 45 comprises a home-automation computing unit in accordance with the invention, named neighbouring computing unit 43, connected by a wired local link 48 to a router 44. Said router 44 provides a communication link between said neighbouring network 45 and the computer server 35 across the Internet. The grouping of the links and nodes (local link 48, router 44 and link between said neighbouring network 45 and the computer server 35) between said neighbouring computing unit 43 and the computer server 35 by the local network 45 and the Internet forms said neighbouring link 46.

Said neighbouring computing unit 43 is adapted to receive home-automation signals from at least one home-automation sensor 60 by a wired communication link, named home-automation link 61.

Said neighbouring computing unit 43 is connected to a user interface device 47, such as a mobile telephone for example, across the local link 48, the router 44, the neighbouring link 46, the computer server 35 and an external link 54.

Furthermore, the main computing unit 30 has a communication link, named translocal link 36, with the first neighbouring computing unit 38, and a translocal link 55 with the second neighbouring computing unit 43. Said local links 36, 55 are advantageously wireless data communication links. More particularly, said local links 36, 55 are advantageously long-range, machine-to-machine, wireless data communication links. They are, for example, advantageously based on a telecommunication technology of the LoRa™ type developed by the company Semtech (Camarillo, Calif., USA) providing a communication link with a range greater than 3 km in urban regions.

Furthermore, if they are within range of each other, the two neighbouring computing units 38, 43 can themselves be connected by a translocal link of the same type.

Advantageously, the main computing unit 30 comprises a memory in which there are stored specific identifiers, named neighbouring identifiers, of each of the neighbouring computing units 38, 43 in the form of a routing table. Said routing table also comprises a quality value associated with each identifier of said neighbouring computing units 38, 43. Said quality value represents the quality of the translocal link 36, 55 between said main computing unit and each respective one of the neighbouring computing units 38, 43. The neighbouring identifiers are ranked by priority order in the routing table based on the quality values associated with the translocal link 36, 55 with said neighbouring computing unit 38, 43 to which each neighbouring identifier corresponds.

Said routing table of each home-automation computing unit 30, 38, 43 is advantageously duplicated in a back-up memory of the computer server 35 or a network of computer servers.

If there is a fault in the main link 33, or a fault in any other element located on a communication link between said main computing unit 30 and the computer server 35 comprising said main link 33, for example a fault on the router 31 or a fault on the local link 50—comparable with a fault on said main link 33 within the scope of the invention—the main computing unit 30 communicates, in particular exchanges data, with the interface device 34 via said translocal link 36, 55 and said neighbouring computing unit 38, 43 whose identifier is ranked first in its routing table. If the main computing unit 30 does not manage to establish a communication link with the computer server 35 across the neighbouring local network 40, 45 of the neighbouring computing unit 38, 43 whose identifier is ranked first in the routing table, the main computing unit 30 tries to establish a communication with the computer server 35 across the neighbouring local network 40, 45 of the neighbouring computing unit 38, 43 whose identifier is ranked second in its routing table, and so on until a communication link is established with the computer server 35 or the main computing unit 30 reaches the last identifier in its routing table.

Thus, for example, if the translocal link 36 with the neighbouring computing unit 38 is of a higher quality than the translocal link 55 with the neighbouring computing unit 43, in a preferential manner said main computing unit 30 establishes a communication link with the computer server 35 via said neighbouring computing unit 38. Nevertheless, if the communication link between the neighbouring computing unit 38 and the computer server 35 is malfunctioning, in particular if the router 39 is out of service or if the neighbouring link 37 is cut, the main computing unit 30 attempts to establish a communication link with the computer server 35 via said neighbouring computing unit 43.

Furthermore, when the neighbouring computing unit 38 sends home-automation messages via said translocal link 36 to the main computing unit 30 because its communication link comprising said neighbouring link 37 with the computer server is cut, the main computing unit 30 sends said data received from the neighbouring computing unit 38 to the computer server 35. However, if the main link 33 (or the local link 50, or the router 31) is also malfunctioning, for example owing to a power cut affecting a complete building in which the main local network 32 and the neighbouring local network 40 are located, then said main computing unit 30 re-sends said data—received from the neighbouring computing unit 38 via the translocal link 36—to the neighbouring computing unit 43 via said translocal link 55. The data from the neighbouring computing unit 38 thus performs in this case two “jumps” from home-automation computing unit to home-automation computing unit prior to re-joining the Internet, the computer server and, if need be, an interface device 41, 42.

Advantageously, said home-automation computing unit (main computing unit 30 and neighbouring computing units 38, 43) comprises a battery allowing it to continue to operate, in particular to communicate by said translocal link 36, 55, even in the absence of a power supply by a power supply network.

FIG. 2 shows an operating diagram of a method implemented in a home-automation device in accordance with the invention as shown in FIG. 1 when installed in the main computing unit.

The two columns on the right show the operations performed by the main computing unit 30. The third column from the right shows the operations performed by the computer server 35. The fourth column from the right shows the operations performed by a neighbouring computing unit 38, 43. The column on the left shows the operations performed by the user interface device 34 of the main computing unit 30.

In step 201, the main computing unit 30 is installed in the main local network 32. More particularly, the main computing unit 30 establishes a connection with the router 31 by a local link 50.

In step 202, the main computing unit 30 establishes a communication link with the computer server 35 via said local link 50, the router 31 and the main link 33 between the main local network 32 and the computer server 35. More particularly, the main computing unit 30 emits a message to the computer server 35.

Upon receipt of such a message, in step 203, the computer server 35 establishes the geographic location of the main computing unit 30 from the Internet address (IP) of the main local network 32 or, more advantageously, from information relating to the main user of said main local network (in general, a subscriber whose postal address is known from a client database).

In step 204, the computer server searches in a database of identifiers of neighbouring computing units 38, 43 theoretically located within the range of the main computing unit 30 by said translocal link which can be established by the main computing unit 30. To this end, the computer server 35 advantageously comprises in its memory a value corresponding to the maximum range of a translocal link and the geographic location of each of the home-automation computing units in accordance with the invention already stored in the computer server 35, in particular of the neighbouring computing units from the main computing unit 30.

In step 205, the computer server 35 emits a message to the main computing unit 30. Said message comprises, if need be, identifiers, named neighbouring identifier, of neighbouring computing units theoretically located within the range of the main computing unit 30 by said translocal link 36, 55 of said main computing unit 30.

Nevertheless, steps 203 to 205 are optional. In accordance with the invention, the main computing unit can pass directly from step 202 to step 207 via line 206. In particular, the main computing unit 30 can ignore steps 203 to 205 when it does not have an operational main link with the computer server 35. The first step of a method in accordance with the invention may thus be step 207.

In step 207, the main computing unit 30 emits a signal, named searching signal, via said translocal link. Said searching signal always comprises at least one identifier of said main computing unit 30. Said identifier is, for example, a MAC address of the main computing unit 30. Furthermore, when the method comprises steps 203 to 205, the searching signal also comprises an identifier of a neighbouring computing unit such that said searching signal is sent to a single neighbouring computing unit, for example neighbouring computing unit 38. Upon the first occurrence of step 207, the main computing unit 30 emits a searching signal comprising the first identifier of a neighbouring computing unit in a list of identifiers emitted by the computer server 35 in step 205.

In step 213, the main computing unit 30 waits to receive a signal representing an acknowledgement from a neighbouring computing unit 38 to which it has emitted a searching signal comprising the identifier of said neighbouring computing unit 38. Step 213 is thus advantageously performed when steps 203 to 205 have been implemented.

In step 213, if a signal representing an acknowledgement has not been received from said neighbouring computing unit 38 after a predetermined time period, named waiting time period, stored in a memory of said main computing unit 30, this passes to step 214.

If, in step 213, a signal representing an acknowledgement has been received from said neighbouring computing unit 38 before the end of the waiting time period, the main computing unit 30 passes to step 215.

In step 214, the main computing unit 30 selects the next neighbouring identifier in the list of neighbouring identifiers which has been sent to it by the computer server 35 in step 205 and then repeats step 207 with this new neighbouring identifier, e.g. that of neighbouring computing unit 43.

In step 208, each neighbouring identifier 38, 43 within the range of the main computing unit 30 receives said searching signal emitted thereby in step 207. If the searching signal comprises a neighbouring identifier, said neighbouring computing unit passes to step 220. If the searching signal does not comprise a neighbouring identifier, said neighbouring computing unit passes directly to step 209.

In step 220, each neighbouring computing unit 38, 43 having received the searching signal compares the neighbouring identifier of the searching signal with its own identifier. If the two identifiers are different, the neighbouring computing unit takes no action. If the neighbouring identifier corresponds to its own identifier, said neighbouring computing unit 38, 42 passes to step 209.

In step 209, the neighbouring computing unit 38 stores the main identifier of said main computing unit 30 and then determines a value, named quality value, representing the quality of the translocal link 36 between the main computing unit 30 and itself. If need be, the neighbouring computing unit updates its own routing table by adding the main identifier of said main computing unit 30 ranked by priority order in its routing table based on said quality value.

In step 210, the neighbouring computing unit 38 emits a signal, named peering signal, comprising at least its identifier as well as the identifier of the main computing unit 30. Said peering signal advantageously also comprises said quality value determined in step 209.

The peering signal emitted by the neighbouring computing unit in step 210 is either emitted directly to the main computing unit 30 via said translocal link 36, which is shown in FIG. 2 by line 212, or emitted to the main computing unit 30 via said neighbouring link 37 and the computer server 35.

When the peering signal is emitted by the neighbouring computing unit 38 via the neighbouring link 37 and the computer server 35, the computer server performs step 211. In step 211, the computer server 35 adds, to the peering signal, an encryption key of the neighbouring computing unit 38 allowing the main computing unit 30 to securely send data to the neighbouring computing unit 38 over said translocal link 36.

In step 215, the main computing unit 30 stores the neighbouring identifier of each neighbouring computing unit 38, 43 having responded to its searching signal by a peering signal. The main computing unit 30 also stores, if need be, each encryption key of each neighbouring computing unit 38, 43 having responded to it by associating it with the identifier of said neighbouring computing unit. Furthermore, the main computing unit 30 also stores the quality value returned by each neighbouring computing unit 38, 43 by associating the identifier of the neighbouring computing unit.

If, in step 207, the main computing unit 30 has only emitted a searching signal comprising a single neighbouring identifier, the main computing unit 30 passes to step 214 as long as it has not contacted all the neighbouring computing units of which the computer server 35 has sent it the list in step 205. If a searching signal has been emitted for all the neighbouring identifiers sent to it by the computer server, or in the case where steps 203 to 205 have not been performed and a general searching signal without a neighbouring identifier has been emitted, the main computing unit 30 passes to step 216.

In step 216, the main computing unit 30 creates a routing table in which the neighbouring identifiers stored in step 215 are ranked based on the quality value associated therewith. Thus, preferentially, the main computing unit 30 will firstly contact the neighbouring computing unit 38, 43 having the best quality of communication over said translocal link 36, 55. Then, the main computing unit emits an information message to the computer server 35 intended for a user interface device 34.

In step 218, the computer server 35 receives said information message via said main link 33, stores in its memory the routing table of the main computing unit, and then sends said information message to the interface device 34 via the external link 51.

In step 219, said interface device 34 displays the informative content of said information message on a screen of said interface device 34.

In step 217, the main computing unit 30 measures a predetermined time period stored in its memory. Whilst the time period is still on-going, the main computing unit does not renew its routing table. As soon as the predetermined time period has expired, the main computing unit 30 repeats steps 207 to 215 at least with the neighbouring identifiers which it has in its memory so as to periodically update its routing table. In fact, the quality values may change over time, and some neighbouring computing units may be uninstalled or be non-operational and thus disappear from the routing table.

Furthermore, when a new neighbouring computing unit 38, 43 is installed within the range of the main computing unit 30 by said translocal link, the main computing unit 30 performs steps 208 to 210 and, in particular, stores the neighbouring identifier of the new neighbouring computing unit 38, 43 and updates its routing table based on the quality value which it determines for the translocal link 36, 55 with this new neighbouring computing unit 38, 43.

FIG. 3 shows a method in accordance with the invention for operating a home-automation computing unit, named main computing unit 30, in accordance with the invention. This corresponds for example to a method for operating a home-automation alarm computing unit.

In step 301, the main computing unit 30 is in an monitoring mode. When the main computing unit 30 detects an anomaly, it passes to step 302.

In step 302, the main computing unit 30 emits a home-automation message which is an alarm message to the computer server 35 by the main link 33, and then passes to step 303.

In step 303, the main computing unit monitors the reception of a signal representing an acknowledgement from the computer server 35 during a predetermined time period, named waiting time period, stored in the memory. If the main computing unit 30 receives an acknowledgement from the computer server prior to the end of said waiting time period, it returns to step 301.

If the main computing unit 30 has not received an acknowledgement from the computer server 35 by the end of the waiting time period, it passes to step 304.

In step 304, the main computing unit 30 re-emits said alarm message over said translocal link 36, 55 to the neighbouring computing unit 38, 43 whose identifier is in first place in its routing table, i.e. the main computing unit 30 emits said alarm message over said translocal link 36, 55 by associating therewith the first neighbouring identifier of its routing table.

In step 305, the main computing unit monitors the reception of a signal representing an acknowledgement from the neighbouring computing unit 38, 43 during a predetermined time period, named waiting time period, stored in the memory. If the main computing unit 30 receives an acknowledgement from the neighbouring computing unit 38, 43 prior to the end of said waiting time period, it returns to step 301.

If the main computing unit 30 has not received an acknowledgement from the neighbouring computing unit 38, 43 by the end of the waiting time period, it passes to step 306.

In step 306, the main computing unit 30 selects from its routing table the neighbouring identifier located directly after the neighbouring identifier previously used in step 304 and then repeats step 304 with the new neighbouring identifier.

Steps 304 to 306 can be repeated a plurality of times for each neighbouring identifier stored in the routing table, i.e. the routing table is run through a number of times until an acknowledgement is received by said main computing unit 30.

In step 307, the main computing unit 30 receives a message from a neighbouring computing unit via said translocal link. It then passes to step 302 and follows the method previously described.

The invention can comprise numerous other embodiment variations, not illustrated.

In particular, numerous variations of a method in accordance with the invention may be envisaged whilst remaining true to the method defined in accordance with the invention.

1-19. (canceled)

20. A home-automation device comprising:
a first home-automation computing unit, named main computing unit (30),
an electronic device, named receiving device (35), connected to said main computing unit (30) by a first data communication link, named main link (33),
said main computing unit (30) belonging to a first local network, named main local network (32), of electronic devices which are distinct and remote from the receiving device (35), this main local network having its own access, via a password, to the Internet, said main link comprising a communication link of the Internet,
said main computing unit (30) being adapted to:
receive signals, named home-automation signals, of at least one home-automation sensor (56), of the main local network,
process said home-automation signals and produce digital data representing a message, named home-automation message, based on said home-automation signals,
be able to emit said home-automation message to said receiving device (35) by said main link (33),
further comprising a second home-automation computing unit, named neighbouring computing unit (38, 43), belonging to a second local network, named neighbouring local network (40, 45), of electronic devices which are distinct and remote from the receiving device (35), this neighbouring local network having its own access, via a password, to the Internet, said neighbouring link comprising a communication link of the Internet,
wherein said receiving device (35) is connected to said neighbouring computing unit (38, 43) by a second data communication link, named neighbouring link (37, 46), distinct from the main link (33),
and wherein said main computing unit is adapted to:
be able to detect a cut in said main link (33),
be able to establish a data communication link, named translocal link (36, 55):
distinct from said main link (33),
distinct from said neighbouring link (37, 46),
with said neighbouring computing unit (38, 43),
upon detection of a cut in said main link (33), be able to re-emit said home-automation message to said neighbouring computing unit (38, 43) by said translocal link (36, 55),
and wherein said neighbouring computing unit (38, 43) is adapted to:
be able to receive, over said translocal link (36, 55), said home-automation message from said main computing unit (30),
be able to emit said home-automation message to said receiving device (35) by said neighbouring link (37, 46).

21. A device according to claim 20, wherein said neighbouring computing unit (38, 43) is further adapted to:
be able to detect a cut in said neighbouring link (37, 46),
upon detection of a cut in said neighbouring link, be able to re-emit said home-automation message to another home-automation computing unit, by said translocal link (36, 55).

22. A device according to claim 20, wherein said neighbouring computing unit (38, 43) is further adapted to:
receive signals, named home-automation signals, of at least one home-automation sensor (58, 60), of the neighbouring local network,
process said home-automation signals and produce digital data representing a message, named home-automation message, based on said home-automation signals.

23. A device according to claim 20, characterised in that:
said main computing unit is connected to an Internet access router by a local link of said main link,
said neighbouring computing unit is connected to an Internet access router by a local link of said neighbouring link.

24. A device according to claim 20, wherein said main computing unit (30) is adapted to re-emit, upon receipt of a home-automation message from said neighbouring computing unit (38, 43) by said translocal link (36, 55) and upon detection of a cut in said main link (33), said home-automation message by said translocal link (36, 55) to a second neighbouring computing unit (38, 43).

25. A device according to claim 20, wherein:
said main computing unit (30) comprises at least one memory in which there is stored at least one identifier, named main identifier, which is specific to it,
said main computing unit is adapted to be able to emit a signal, named searching signal, comprising said main identifier, by said translocal link (36, 55),
said neighbouring computing unit (38, 43) comprises at least one memory in which there is stored at least one identifier, named neighbouring identifier, which is specific to it,
said neighbouring computing unit is adapted to emit, upon receipt of said searching signal, a signal, named peering signal, comprising said neighbouring identifier, by said translocal link,
said main computing unit is adapted to store, upon receipt of said peering signal, said neighbouring identifier in a memory.

26. A device according to claim 20, wherein said translocal link (36, 55) is a wireless communication link.

27. A device according to claim 20, wherein said translocal link (36, 55) is an encrypted communication link.

28. A device according to claim 20, wherein the receiving device is a computer server (35).

29. A device according to claim 28, wherein said computer server (35) is adapted to be able to communicate by a telecommunication network with at least one human user interface device (34, 41, 42, 47).

30. A device according to claim 28, wherein:
said main computing unit (30) is adapted to be able to emit a first message, named registration message, to the computer server (35) via said main link (33),
said computer server (35) is adapted to produce and send to said main computing unit, upon receipt of said registration message, a response message containing at least one identifier, named neighbouring identifier, of at least one neighbouring computing unit (38, 43),
said main computing unit is adapted to be able to emit by said translocal link (36, 55) a signal, named searching signal, comprising:
at least one identifier, named main identifier, which is specific to it,
said neighbouring identifier.

31. A device according to claim 20, wherein, upon receipt of a home-automation message by said translocal link (36, 55), said neighbouring computing unit (38, 43) is adapted to send said home-automation message to said receiving device (35) by said neighbouring link (37, 46) only if said home-automation message is established in accordance with a predetermined communication protocol, named home-automation translocal protocol.

32. A device according to claim 20, wherein at least one home-automation sensor (56, 58, 60) is selected from: a fire detector, a movement detector, in particular an infrared detector, a leaf-opening detector, an accelerometric detector, a magnetometric detector, a camera, a microphone, a power supply outage detector, a contact detector, a water detector, a thermometer, a luxmeter in particular a photovoltaic sensor, a gas detector, in particular a carbon monoxide detector, an oxygen level detector, a carbon dioxide detector, a water vapour level detector, in particular a humidity level sensor, a seismic detector, a glass break detector, a detector of breakdowns or faults in electrical or mechanical devices, an emergency call or assistance pendant, a water consumption sensor in particular a water meter, an electricity consumption sensor, in particular an electricity meter, a gas consumption sensor, in particular a gas meter, a fuel consumption sensor, a GPS locating device, a tachometer, a pressure sensor, an anemometer, a person-monitoring sensor, in particular a heart-rate sensor, a blood pressure sensor, an oxygen saturation sensor, a respiratory rate sensor.

33. A method implemented in a home-automation computing unit, named main computing unit (30), in which said main computing unit:
receives signals, named home-automation signals, of at least one home-automation sensor (56),
processes said home-automation signals and produces digital data representing a message, named home-automation message, based on said home-automation signals,
emits signals representing a message, named home-automation message, to a receiving device (35) by a first data communication link, named main link (33), comprising a communication link of the Internet, said main computing unit belonging to a first local network, named main local network (32), of electronic devices which are distinct and remote from the receiving device (35), this main local network having its own access, via a password, to the Internet,
wherein said main computing unit:
detects a cut in said main link (33),
re-emits said home-automation message over a data communication link, named translocal link (36, 55), distinct from the main link (33), to a second home-automation computing unit, named neighbouring computing unit (38, 43), adapted to be able to emit said home-automation message to said receiving device (35) by a second data communication link, named neighbouring link (37, 46), comprising a communication link of the Internet, distinct from the main link (33), said neighbouring computing unit (38, 43) belonging to a second local network, named neighbouring local network (40, 45), of electronic devices which are distinct and remote from the receiving device (35), this neighbouring local network having its own access, via a password, to the Internet.

34. A method according to claim 33, wherein, upon receipt of a home-automation message from a first neighbouring computing unit (38, 43) via said translocal link (36, 55), and upon detection of a cut in said main link (33), said main computing unit (30) re-emits said home-automation message to a second neighbouring computing unit (38, 43) via said translocal link (36, 55).

35. A home-automation computing unit, named main computing unit (30), adapted to:
receive signals, named home-automation signals, of at least one home-automation sensor (56),
process said home-automation signals and produce digital data representing a message, named home-automation message, based on said home-automation signals,
be able to emit said home-automation message to a receiving device (35) by a first data communication link, named main link (33), comprising a communication link of the Internet, said main computing unit belonging to a first local network, named main local network (32), of electronic devices which are distinct and remote from the receiving device (35), this main local network having its own access, via a password, to the Internet,
wherein it is adapted to:
be able to detect a cut in said main link (33),
be able to establish a data communication link, named translocal link (36, 55):
distinct from the main link (33),
with a second home-automation computing unit, named neighbouring computing unit (38, 43), adapted to be able to emit said home-automation message to said receiving device (35), by a second data communication link, named neighbouring link (37, 46), comprising a communication link of the Internet, distinct from the main link (33) and the translocal link (36, 55), said neighbouring computing unit (38, 43) belonging to a second local network, named neighbouring local network (40, 45), of electronic devices which are distinct and remote from the receiving device (35), this neighbouring local network having its own access, via a password, to the Internet,
upon detection of a cut in said main link (33), be able to re-emit said home-automation message to said neighbouring computing unit (38, 43) by said translocal link (36, 55).

36. A computing unit according to claim 35, wherein it is adapted to re-emit, upon receiving a home-automation message from said neighbouring computing unit (38, 43) by said translocal link (36, 55), said home-automation message by said main link (33).

37. A computing unit according to claim 35, wherein it is adapted to re-emit, upon receipt of a home-automation message from said neighbouring computing unit (38, 43) by said translocal link (36, 55) and upon detection of a cut in said main link (33), said home-automation message by said translocal link (36, 55) to a second neighbouring computing unit (38, 43).

38. A computing unit according to claim 35, wherein it comprises at least one memory adapted to be able to store a plurality of distinct identifiers for distinct neighbouring computing units (38, 43).

39. A device according to claim 21, wherein said neighbouring computing unit (38, 43) is further adapted to:
receive signals, named home-automation signals, of at least one home-automation sensor (58, 60), of the neighbouring local network,
process said home-automation signals and produce digital data representing a message, named home-automation message, based on said home-automation signals.
